(19) United States
(12) Patent Application Publication
(10) Pub. No.: US 2019/0163430 A1
(43) Pub. Date: May 30, 2019

(54) DIGITAL SIGNAGE SYSTEM

(71) Applicant: Acer Incorporated, New Taipei City (TW)

(72) Inventor: Chun-Hua LEE, New Taipei City (TW)

(21) Appl. No.: 16/199,011

(22) Filed: Nov. 23, 2018

(30) Foreign Application Priority Data
Nov. 28, 2017 (TW) 106141349

(51) Int. Cl. G06F 3/147; G06T 7/00; G09G 5/00; G06F 11/14

(52) U.S. Cl. CPC G06F 3/147; G06T 7/0002; G06F 9/445; G06F 11/1438; G09G 2330/12; G09G 5/006

(57) ABSTRACT

This invention provides a digital signage system including a display device and a host device. The host device includes a playing unit and a monitoring unit. The playing unit plays signage content on the display unit. The monitoring unit captures a first image displayed on the display device after the digital display system is powered on. After the display device experiences a specific event, the monitoring unit captures a second image displayed on the display device when the playing unit is playing. The monitoring unit compares the first image and the second image to determine whether the display device displays abnormally.

### CROSS REFERENCE TO RELATED APPLICATIONS

This Application claims priority of Taiwan Patent Application No. 106141349, filed on Nov. 28, 2017, the entirety of which is incorporated by reference herein.

### BACKGROUND OF THE INVENTION

### Field of the Invention

The present invention relates to a digital signage system, and it especially relates to a digital signage system which can determine that it is displaying abnormally and repair itself.

### Description of the Related Art

With the rapid progress being made in the technologies used in computers and large scale display devices, digital signage systems (also called public information systems) have become increasingly common nowadays. One of the assembly methods for a digital signage system is to link a playing host device with an external display device. This assembly method can reduce the cost of digital signage systems and provide greater flexibility in implementation and future upgrades.

As with general-purpose computers, the playing host devices used in digital signage systems can also run on a commercially available operating system (OS), but these playing host devices are usually equipped with limited computing capabilities and memory sizes. Display devices nowadays usually come with high resolutions and hence various commercial operating systems (like the Microsoft Windows operating system) have the function of adjusting the scaling ratio of the displayed windows and other displayed content (hereinafter referred to as scaling setting). In the example of the Microsoft Windows OS, the scaling setting uses a number to represent the level of scaling. When the scaling setting is set to 100, the displayed window size and other content are displayed at the default size with no enlargement. When the scaling setting is set to a value higher than 100, e.g., 125 or 150, the displayed window size and other content are enlarged in proportion to the value set for the scaling setting. When the scaling setting is set to a number other than 100, and when the display device is powered off and then powered on again, or a signal wire has been removed and then reconnected, the sizes or positions of the windows of currently-running programs may change. In the example of a digital signage system, when a playing host device running Microsoft Windows OS with scaling set to 150 runs a playing program (e.g. the Microsoft Media Player) in full-screen mode and the display device is powered off and then powered on again, the playing program may leave the full-screen mode and continuously run in window-mode with a smaller window. This circumstance may cause the digital signage system to not be able to show the correct content.

### BRIEF SUMMARY OF THE INVENTION

The present invention provides a digital signage system, which can determine that it is displaying abnormally and repair the issue itself, to solve the above-mentioned issue of playing programs displaying abnormally. The digital signage system of the present invention comprises a display device and a host device. The host device comprises a playing unit which plays board content on the display device; and a monitoring unit, which captures a first image displayed on the display device after the digital signage system is powered up; after the digital signage system experiences a specific event, the monitoring unit captures a second image displayed on the display device when the playing unit is playing; and determines whether the playing unit is displaying abnormally by comparing the first image with the second image.

The present invention provides the digital signage system described above, wherein the specific event is the display device being powered off and then powered on again, or a signal wire connecting the host device and the display device has been removed and then reconnected.

The present invention provides the digital signage system described above, wherein when the difference between the first image and the second image is smaller than a predetermined ratio, the monitoring unit determines that the playing unit is displaying abnormally.

The present invention provides the digital signage system described above, wherein the host device is a playing host device with limited hardware resources.

The present invention provides the digital signage system described above, wherein the playing host device comprises a processor, executing a first program to implement functional operations of the monitoring unit and executing a second program to implement functional operations of the playing unit.

The present invention provides the digital signage system described above, when the monitoring unit determines that the playing unit is displaying abnormally, the monitoring unit informs the processor to relaunch the second program.

The present invention provides the digital signage system described above, wherein when the processor has relaunched the second program more than a predetermined number of times, the monitoring unit captures a third image displayed on the display device when the playing unit is playing, and if the monitoring unit determines that the playing unit is displaying abnormally after comparing the first image with the third image, the monitoring unit sends out an error notice.

The present invention provides the digital signage system described above, wherein the monitoring unit determines whether the playing unit is displaying abnormally by determining whether the scaling ratio of a playing window of the playing unit within the display device is abnormal when the playing unit is playing.

### BRIEF DESCRIPTION OF THE DRAWINGS

The present invention can be more fully understood by reading the subsequent detailed description and examples with references made to the accompanying drawings, wherein:

FIG. 1 is a schematic block diagram of a digital signage system according to an embodiment of the present invention.

FIG. 2 is an error detection/repair method of the digital signage system according to an embodiment of the present invention.

FIG. 3A is an exemplary diagram of an image shown on the display device according to an embodiment of the present invention.

FIG. 3B is an exemplary diagram of an image shown on the display device according to an embodiment of the present invention.

FIG. 3C is an exemplary diagram of an image shown on the display device according to an embodiment of the present invention.

FIG. 3D is a comparison image of the images shown on the display device according to an embodiment of the present invention.

### DETAILED DESCRIPTION OF THE INVENTION

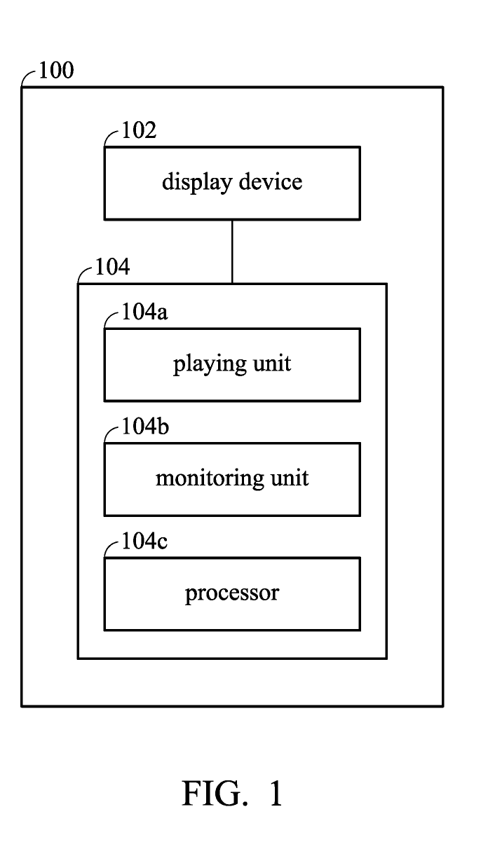

FIG. 1 is the schematic block diagram of a digital signage system according to an embodiment of the present invention. The digital signage system 100 comprises a display device 102 and a host device 104. The display device 102 is used for displaying content that the digital signage system 100 intends to display. The host device 104 is electrically connected to the display device 102 and controls the displaying content of the digital signage system 100.

The host device 104 comprises a playing unit 104a, a monitoring unit 104b, and a processor 104c. In this embodiment, the host device 104 is a host computer running an OS with windows functionality, such as the Microsoft Windows OS. The playing unit 104a and the monitoring unit 104b are respectively the playing program (e.g. the Microsoft Media Player) and the monitoring program running within the Microsoft Windows OS. The processor 104c executes the playing program to implement the functional operations of the playing unit, and it executes the monitoring program to implement the functional operations of the monitoring unit, but the present invention is not limited thereto. The host device 104 can be any device that can control the displaying content of the digital signage system 100, and the playing unit 104a and the monitoring unit 104b can be any hardware and/or software combination running within the host device 104.

In this embodiment, the display device 102 is a high-resolution monitor, but it is not limited thereto. The display device 102 can be any device that can display the content of the digital signage system 100. High-resolution monitors can display pictures and videos more clearly, but the displayed pictures and videos may appear to be too small in size. For example, considering a first monitor and a second monitor with the same physical size and resolutions of 1920×1080 and 1280×720 respectively, when showing a window with a size of 1280×720, the window only occupies 4/9 of the screen area on the first monitor, but it would occupy the entire screen area of the second monitor. Hence, the occupied area of the window on the first monitor is less than half of the occupied area of the window on the second monitor, and it may appear to be too small to viewers.

As described above, high-resolution monitors may results in displaying undersized windows, and hence various OSs have the function of adjusting the scaling ratio of the sizes of the displayed windows (the scaling setting) to allow the user to select the proper size of the windows and their displaying content without adjusting the resolution configured by the OS. The functioning principle of the scaling setting is to adjust the scaling ratio of the windows with software without changing the actual resolution of the OS. When the scaling setting is set to a high value, such as a number higher than 100 in the Microsoft Windows OS, the OS uses more pixels to show objects (including windows interfaces, pictures, tests, etc.) which originally require fewer pixels to be shown on the monitor, and it results in the enlargement of the windows and their content on the monitor. Since the scaling setting does not change the actual output resolution of the Microsoft Windows OS, it can achieve the effect of adjusting windows sizes without sacrificing high resolution.

The scaling setting would be implemented in all running application functions in the OS, and hence there are two factors in determining the window size of an application program: the output resolution of the OS and the value of the scaling setting. If a newer software development platform is being used in the Microsoft Windows OS, such as the Universal Windows Platform, the developed application programs have the Application Programming Interfaces (APIs) which supports high scaling settings, and hence the sizes and locations of the windows can be displayed correctly at all scaling settings. If an older software development platform is being used, such as the Win32 platform, the APIs of the developed application programs may not support the scaling setting. Hence when the Microsoft Windows OS implements the scaling setting in application programs which do not support scaling, the Microsoft Windows OS can only proportionally enlarge/shrink the APIs of the application programs, and errors may occur. One common error in a digital signage system is described below.

If the API of a playing program does not support scaling, one common error is the following. Considering a host device running the Microsoft Windows OS with the value for scaling setting higher than 100 (i.e., high scaling setting), connected to an external monitor with a High Definition Multimedia Interface (HDMI) cable, and running the playing program in full-screen mode; when the external monitor is powered off and then powered on again, or the signal cable (i.e., the HDMI cable) is removed and then reconnected, the playing program may leave the full-screen mode and returns to a window-mode with a smaller window.

The reason for the error may be: when the playing program is first being launched, the value for the scaling setting is larger than 100 but the playing program does not support high scaling settings, hence the Microsoft Windows OS enlarges the API of the playing program proportionally when launching the playing program. When the external monitor is powered off and then powered on again, or the signal cable is removed and then reconnected, the Microsoft Windows OS receives the resolution sent from the external monitor again and the playing program updates its API when detecting the resolution of the external monitor. Since the API of the playing program does not support high scaling settings, the updated API of the playing program would return to the state where the scaling setting is 100 (i.e., the state where the window is not enlarged) and the window of the playing program returns to a smaller size.

Since playing programs are commonly designed by third-party developers, it is unrealistic to ask the original developers to fix the issue and support high scaling settings. It is also unrealistic to ask Microsoft to achieve perfect downward compatibility to all Win32 software. Since the host device 104 in the digital signage system 100 may be equipped with limited memory sizes and hardware commutating capabilities, monitoring/repair methods with high complexity may affect the operation of the playing program and are hard to implement in the digital signage system 100. In addition, digital signage systems needs the function of closing their display devices to achieve power savings, hence the present invention provides a solution to the above-mentioned issue.

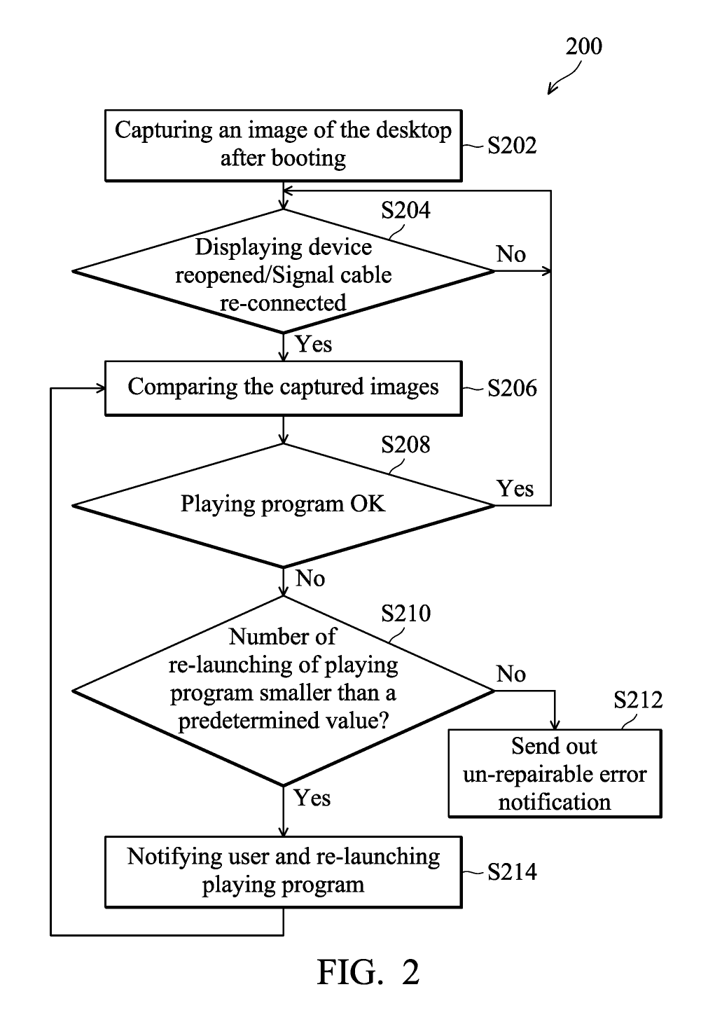

In this embodiment, the monitoring unit uses a simple method to detect whether the playing program is playing in the right position and at the right size. The simple method further repairs any incorrect position/size issues of the playing program. FIG. 2 is an error detecting/repair method 200 for the playing program according to an embodiment of the present invention.

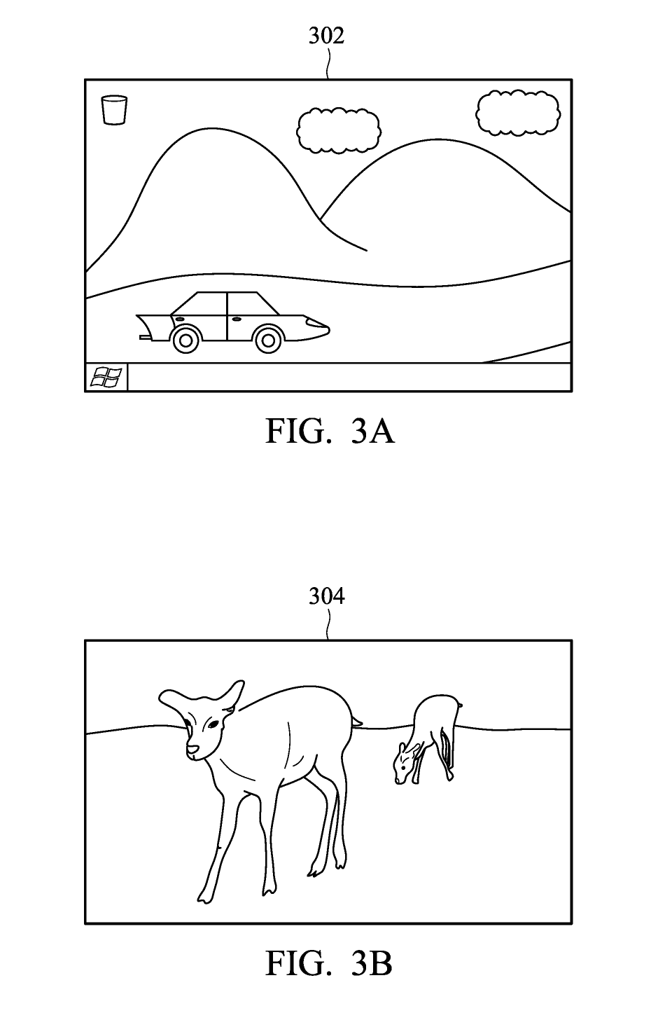

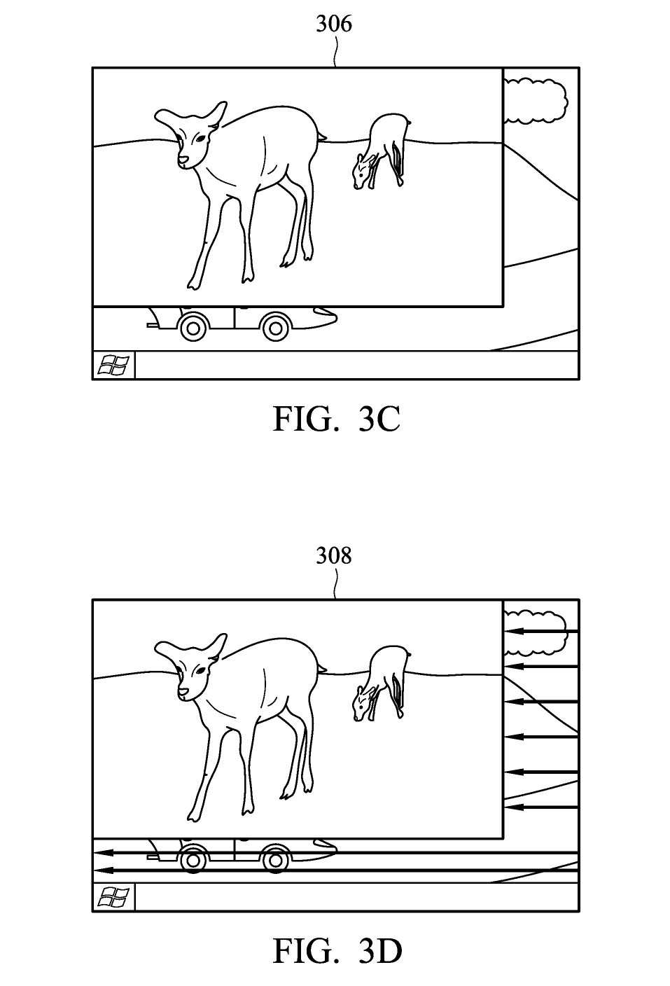

In step S202, the monitoring unit 104b captures a screenshot of the image showing on the display device 102 as the first image right after the host device 104 finishes booting. FIG. 3A is an exemplary diagram of the first image. Since the host device 104 runs the Microsoft Windows OS in this embodiment, the first image 302 shown in FIG. 3A is simply an initial user interface of the Microsoft Windows OS, which is the so-called Windows desktop. In addition, since the host device 104 just finishes booting and is not running any programs at the time (including the playing program), the first image 302 can serve as a good reference image.

After the monitoring unit 104b captures the first image 302, the host device 104 starts executing a playing program (i.e., the functionality of the playing unit 104a). In this embodiment, the playing program is executed in the full-screen mode.

After the play program starts running, the monitoring unit 104b performs step S204 and begins continuously monitoring whether the display device 102 has been powered-off and then powered on again, or the HDMI cable has been removed and then reconnected.

When the monitoring unit detects in step S204 that the display device 102 has been powered-off and then powered on again, or that the HDMI cable has been removed and then reconnected, the monitoring unit 104b performs step S206 and captures a screenshot of the image showing on the display device 102 as the second image when the playing program is playing. FIG. 3B is an exemplary diagram of the second image. In the second image 304 in FIG. 3B, the playing program is still running in the full-screen mode. FIG. 3C is another exemplary diagram of the second image. In the second image 306 in FIG. 3C, the playing program has left the full-screen mode and returned to a window-mode with a smaller window. Hence the area which is not covered by the playing program in the second image 306 is also part of the Windows desktop of the Microsoft Windows OS.

In step S208, the monitoring unit 104b further compares the difference between the first image and the second image after capturing the second image. The comparison can be a pixel-to-pixel comparison, which determines whether the pixels at the same positions in the two images have the same colors, and calculates the ratio of the number of pixels at the same positions in the two images that are with different colors to the total number of pixels. But it is not limited thereto. Any method that can calculate the differences between the two images can be used in the present invention.

When the monitoring unit 104b finds that the difference between the first image and the second image is smaller than a predetermined ratio after the comparison, it determines that the scaling proportion and location of the playing program is incorrect, i.e., it is displaying abnormally. In this embodiment, since the playing program is supposed to play in full-screen mode under normal circumstances, it would cover the entire Microsoft Windows desktop and the difference between the first image and the second image should be close to 100%. Hence when the difference between the first image and the second image is smaller than 99% (for example, but not to be limited thereto), the monitoring unit 104b determines that the playing program is displaying abnormally.

In the embodiment where the second image is the second image 304 of FIG. 3B, since the playing program is still running in full-screen mode, the difference between the first image 302 and the second image 304 is 100%, and the monitoring unit 104b determines that the playing program is displaying normally. Under the circumstances where the playing program is displaying normally, the monitoring unit 104b returns to step S204 and continuously monitors whether the display device 102 has been powered-off and then powered on again, or the HDMI cable has been removed and then reconnected.

In the embodiment where the second image is the second image 306 of FIG. 3C, since the playing program has returned to the window-mode with a smaller window, the second image 206 and the first image 302 have certain parts in common. FIG. 3D is a comparison image 208 which is the overlapping of the first image 302 and the second image 306, wherein the part with the arrows of comparison image 208 is the common part of the first image 302 and the second image 306. In this embodiment, since the different part of the first image 302 and the second image 306 is limited to the position of the playing program and it is smaller than 99%, the monitoring unit 104b determines that the playing program is displaying abnormally and performs step S210.

When the monitoring unit 104b determines the playing program is displaying abnormally, it can further send out a user notice to inform the user that the playing program is displaying abnormally. The user notification can be a hardware format notification, such as an external indication light outside of the host device 104 (not shown in figures); or a software format notification, such as an email or a text message, etc.

In step S210, the monitoring unit 104b determines whether the number of relaunches of the playing program is lower than a predetermined value. If the statement is false, the monitoring unit 104b performs step S212 and sends out a user notification indicating an un-repairable error. If the statement is true, the monitoring unit 104b performs step S214.

In step S214, the monitoring unit 104b informs the processor 104c to close and relaunch the playing program. After the playing program is relaunched, the monitoring unit 104b returns to step S206 to check whether the relaunched playing program is displaying normally.

It is worth noting that steps S206 to S214 of the method 200 can be viewed as a repair process repeatedly executed by the monitoring unit 104b, and the upper limit of the number of executed repair processes is the predetermined value in step S210. When the number of times the repair process has been executed exceeds the predetermined value, it means that the playing program cannot be repaired by relaunching, and the repair process is stopped.

The specification and drawings are, accordingly, to be regarded in an illustrative rather than a restrictive sense. It will, however, be evident that various modifications and changes can be made thereunto without departing from the broader spirit and scope of the patent application as set forth in the claims.

What is claimed is:

1. A digital signage system, comprising:
a display device; and
a host device, comprising
a playing unit, playing board content on the display device; and
a monitoring unit, capturing a first image displayed on the display device after the digital signage system is powered up; after the digital signage system experiences a specific event, capturing a second image displayed on the display device when the playing unit is playing; and determining whether the playing unit displays abnormally by comparing the first image with the second image.

2. The digital signage system of claim 1, wherein the specific event is that the display device has been powered off and then powered on again, or that a signal wire connecting the host device to the display device has been disconnected and then reconnected.

3. The digital signage system of claim 1, wherein when the difference between the first image and the second image is smaller than a predetermined ratio, the monitoring unit determines that the playing unit is displaying abnormally.

4. The digital signage system of claim 1, wherein the host device is a playing host device with limited hardware resources.

5. The digital signage system of claim 4, wherein the playing host device, which comprises a processor, executes a first program to implement functional operations of the monitoring unit and executes a second program to implement functional operations of the playing unit.

6. The digital signage system of claim 5, when the monitoring unit determines that the playing unit displays abnormally, the monitoring unit informs the processor to relaunch the second program.

7. The digital signage system of claim 6, wherein when the processor has relaunched the second program more than a predetermined number of times, the monitoring unit captures a third image displayed on the display device when the playing unit is playing, and if the monitoring unit determines that the playing unit displays abnormally by comparing the first image with the third image, the monitoring unit sends out an error notice.

8. The digital signage system of claim 1, wherein the monitoring unit determines whether the playing unit displays abnormally by determining whether a scaling ratio of a playing window provided by the playing unit within the display device is abnormal when the playing unit is playing.
